(19) United States
(12) Patent Application Publication
(10) Pub. No.: US 2025/0256153 A1
(43) Pub. Date: Aug. 14, 2025

(54) SYSTEMS AND METHODS FOR AN IMPROVED FITNESS STAIR MACHINE

(71) Applicant: STEPR PTY LTD., Gold Coast (AU)

(72) Inventors: Daniel Alenaddaf, Gold Coast (AU); Hyden Thorneycroft, Gold Coast (AU)

(21) Appl. No.: 19/121,073

(22) PCT Filed: Oct. 21, 2023
(86) PCT No.: PCT/IB2023/060643

§ 371 Date: Apr. 14, 2025

Related U.S. Application Data
(60) Provisional application No. 63/380,548, filed on Oct. 21, 2022.
(60) Provisional application No. 63/505,294, filed on May 31, 2023.
(60) Provisional application No. 63/508,285, filed on Jun. 15, 2023.

(51) Int. Cl. A63B 22/04; A63B 24/00; A63B 71/00; A63B 71/06

(52) U.S. Cl. CPC A63B 22/04; A63B 24/0062; A63B 71/0054; A63B 71/0619; A63B 2024/0065; A63B 2071/0081; A63B 2071/0658; A63B 2220/30

(57) ABSTRACT

An exemplary embodiment of the present disclosure relates to a method and system for an improved fitness machine. The fitness system can include a moveable step and a track configured to guide at least a portion of the moveable step along the track. The fitness system can also include a strip disposed on the track comprising of polyurethane material and configured to reduce sound output by the fitness machine. The fitness system can also include a controller configured to receive instructions comprising a predetermined speed sequence from a remote server and automatically adjusting a speed for the moveable step along the track based on the predetermined speed sequence.

### CROSS-REFERENCE TO RELATED APPLICATIONS

This application claims the benefit of: U.S. Provisional Application No. 63/380,548 filed Oct. 21, 2022; U.S. Provisional Application No. 63/505,294 filed May 31, 2023; and U.S. Provisional Application No. 63/508,285 filed Jun. 15, 2023. All above identified applications are hereby incorporated herein by reference in their entirety as if set forth in full below.

### FIELD

The presently disclosed subject matter relates generally to a fitness machine and, more particularly, to a system and methods for improving a fitness stair machine.

### BACKGROUND

Fitness stair machines today typically include outdated features and are too large and expensive for home users to purchase. For example, existing fitness stair machines generally require a user to manually adjust the speed of the fitness machine to a desired or required speed to follow an exercise program or instructor. During a workout session, a program or class may be instructed to increase or decrease the speed of the machine for a set period of time. The program or class may take the user through a sequence of speeds to create a workout program, and to follow the sequence of speeds, but a user typically must manually adjust the speed settings on the fitness machine.

The traditional approach lacks the ability to automatically adjust the speed and does not include additional features to prolong the life of the fitness machine. Traditional fitness stair machines can face problems related to noise levels, moisture exposure, and more. Therefore, what is needed is a way to create an at-home connected fitness experience for users of the fitness stair machines by having an improved fitness stair machine with enhanced features.

### SUMMARY

According to some embodiments, there is provided a fitness machine including: a moveable step, a track that can be configured to guide at least a portion of the moveable step along the track, and a strip that can be disposed on the track. In some embodiments, the strip can be configured to reduce sound output by the fitness machine.

According to some embodiments, there is provided a system including: a moveable step, a track that can be configured to guide at least a portion of the moveable step along the track, and a controller that can be configured to receive instructions from a remote server. The instructions can include a predetermined speed sequence. The controller can further be configured to automatically adjust a speed of the moveable step along the track based on the predetermined speed sequence.

According to some embodiments, there is provided a system including: a processor, and a memory in communication with the processor and storing instructions that when executed by the processor can be configured to cause the fitness system to: transmit a signal to a fitness machine. In some embodiments, the signal can be transmitted to control the fitness machine by controlling a motor of the fitness machine to move a step along a track of the fitness machine at a predetermined speed.

### BRIEF DESCRIPTION OF THE DRAWINGS

Reference will now be made to the accompanying drawings, which are not necessarily drawn to scale, and which are incorporated into and constitute a portion of this disclosure, illustrate various implementations and aspects of the disclosed technology and, together with the description, serve to explain the principles of the disclosed technology. In the drawings:

FIG. 1 is a flowchart illustrating a method for controlling a fitness machine from a remote server.

FIG. 2 is a perspective view of an example fitness machine according to an example embodiment.

FIG. 3 illustrates an example image of a strip on a track of a fitness machine according to an example embodiment.

FIG. 4 illustrates an example image of a strip on a track of a fitness machine according to an example embodiment.

FIG. 5 illustrates an example image of a strip on a track of a fitness machine according to an example embodiment.

FIG. 6 illustrates an example image of a track of a fitness machine according to an example embodiment.

FIG. 7 illustrates an example image of a threaded hole for a removable transport handle of a fitness machine according to an example embodiment.

FIG. 8 illustrates an example image of a threaded hole for a removable transport handle of a fitness machine according to an example embodiment.

FIG. 9 illustrates an example image of a removable transport handle of a fitness machine according to an example embodiment.

FIG. 10 illustrates an example image of a removable transport handle and a sensor of a fitness machine according to an example embodiment.

FIG. 11 illustrates an example image of internal electrical components of a fitness machine according to an example embodiment.

FIG. 12 is an example illustration of a shield of internal electrical components of a fitness machine according to an example embodiment.

FIG. 13 is an example user interface according to an example embodiment.

FIG. 14A is an example perspective view of an illustration of an example fitness machine according to an example embodiment. FIG. 14B is an example front view of an illustration of an example fitness machine according to an example embodiment. FIG. 14C is an example perspective view of an illustration of an example fitness machine according to an example embodiment. FIG. 14D is an example front view of an illustration of an example fitness machine according to an example embodiment.

FIG. 15A is an example perspective view of a fitness machine according to an example embodiment. FIG. 15B is an example front view of a fitness machine according to an example embodiment. FIG. 15C is an example perspective view of a fitness machine according to an example embodiment. FIG. 15D is an example perspective view of a fitness machine according to an example embodiment.

FIGS. 16A and 16B are example perspective views of a rotatable touchscreen of a fitness machine according to an example embodiment.

FIGS. 17A, 17B and 17C are example perspective views of a rotatable touchscreen of a fitness machine according to an example embodiment.

FIGS. 18A, 18B and 18C are example perspective views of graphical user interfaces displaying application on a rotatable touchscreen of a fitness machine according to an example embodiment.

FIG. 19 is an example perspective view of a fitness machine with anchor points according to an example embodiment.

FIG. 20 is an example perspective view of a fitness machine with anchor points according to an example embodiment.

### DETAILED DESCRIPTION

The present disclosure can be understood more readily by reference to the following detailed description of exemplary embodiments and the examples included herein. Before the exemplary embodiments of the devices and methods according to the present disclosure are disclosed and described, it is to be understood that embodiments are not limited to those described within this disclosure. Numerous modifications and variations therein will be apparent to those skilled in the art and remain within the scope of the disclosure. It is also to be understood that the terminology used herein is for describing specific embodiments only and is not intended to be limiting. Some embodiments of the disclosed technology will be described more fully hereinafter with reference to the accompanying drawings. This disclosed technology may, however, be embodied in many different forms and should not be construed as limited to the embodiments set forth therein.

In the following description, numerous specific details are set forth. But it is to be understood that embodiments of the disclosed technology may be practiced without these specific details. In other instances, well-known methods, structures, and techniques have not been shown in detail in order not to obscure an understanding of this description. References to “one embodiment,” “an embodiment,” “example embodiment,” “some embodiments,” “certain embodiments,” “various embodiments,” etc., indicate that the embodiment(s) of the disclosed technology so described may include a particular feature, structure, or characteristic, but not every embodiment necessarily includes the particular feature, structure, or characteristic. Further, repeated use of the phrase “in one embodiment” does not necessarily refer to the same embodiment, although it may.

Unless otherwise noted, the terms used herein are to be understood according to conventional usage by those of ordinary skill in the relevant art. In addition to any definitions of terms provided below, it is to be understood that as used in the specification and in the claims, “a” or “an” can mean one or more, depending upon the context in which it is used. Throughout the specification and the claims, the following terms take at least the meanings explicitly associated herein, unless the context clearly dictates otherwise. The term “or” is intended to mean an inclusive “or.” Further, the terms “a,” “an,” and “the” are intended to mean one or more unless specified otherwise or clear from the context to be directed to a singular form.

Unless otherwise specified, the use of the ordinal adjectives “first,” “second,” “third,” etc., to describe a common object, merely indicate that different instances of like objects are being referred to and are not intended to imply that the objects so described must be in a given sequence, either temporally, spatially, in ranking, or in any other manner.

Also, in describing the exemplary embodiments, terminology will be resorted to for the sake of clarity. It is intended that each term contemplates its broadest meaning as understood by those skilled in the art and includes all technical equivalents that operate in a similar manner to accomplish a similar purpose.

To facilitate an understanding of the principles and features of the embodiments of the present disclosure, exemplary embodiments are explained hereinafter with reference to their implementation in an illustrative embodiment. Such illustrative embodiments are not, however, intended to be limiting.

The materials described hereinafter as making up the various elements of the embodiments of the present disclosure are intended to be illustrative and not restrictive. Many suitable materials that would perform the same or a similar function as the materials described herein are intended to be embraced within the scope of the example embodiments. Such other materials not described herein can include, but are not limited to, materials that are developed after the time of the development of the disclosed technology, for example.

Reference numbers throughout the figures indicate that a particular feature or object is being referred to.

Embodiments of the disclosed technology include a fitness stair machine for a user to work out. In various embodiments, the fitness stair machine or fitness machine can have improvements or enhancements to: allow the user to target additional muscles to workout, prolong the life of the fitness machine, or entertain the user during the use of the fitness machine. The fitness stair machine according to the present disclosure can be used by users at home and provides features convenient to the user. It will be understood that the fitness machine described herein can include any of the embodiments described in detail below.

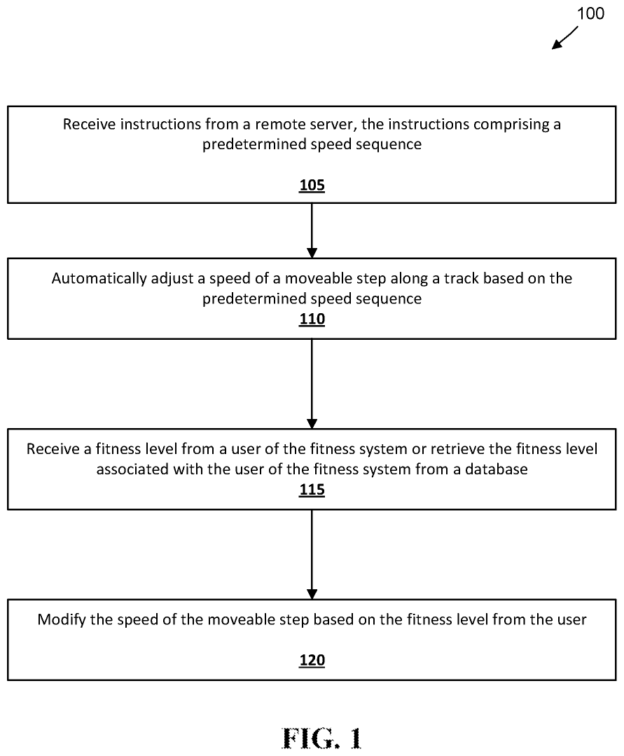

Various devices and methods are disclosed for providing and using a fitness machine 200, or in particular a fitness stair machine, and exemplary embodiments of the devices and methods will now be described with reference to the accompanying figures. FIG. 1 is a flowchart illustrating a method for controlling a fitness machine 200 according to an example embodiment. The process 100 of FIG. 1 can begin with receiving 105 instructions from a remote server. The remove server can send the instructions after having received the instructions from a remote device (such as a controller) or an application. The instructions can be received from the remote server to control any available feature or setting on the fitness machine 200. In this non-limiting example, the instructions can comprise a predetermined speed sequence. The predetermined speed sequence can comprise at least two predetermined speeds and can be synced to a video stream. The video stream can be displayed on a screen 215 on the fitness machine 200 and be streamed on a graphical user interface of the screen 215 in real time. The video stream can also be prerecorded and selected by the user of the fitness machine 200. The video stream can comprise instructions from a workout instructor. The video streams can be stored in a memory of the fitness machine 200 to allow for the fitness machine to have on demand pre-recorded coached classes available on the fitness machine 200 to be displayed on a graphical user interface of the touchscreen 215. These integrated video streams can dynamically align a workout pace with that of the recorded coach on the video stream as outlined below.

The instructions comprising the predetermined speed sequence can be aligned with the instructions from the instructor to change the speed of the fitness machine automatically. These embodiments permit the fitness machine 200 to align with the guidance offered by on-demand coaches or the captivating scenic sessions displayed on the touchscreen 215 or accessed through a customized application platform and related software ecosystem. This embodiment can allow video streams and classes to automatically sync the speed of the instructions from a coach on the screen to the fitness machine 200 meaning the user will not have to touch any button to control the increase or decrease in speed throughout the workout whilst the instructor virtually controls the speed of the user's unit's steps. This synchronization is not only precise but also adaptive, allowing users to remain challenged while maintaining a safe and enjoyable workout experience. The speed of the fitness machine 200 can also be adjusted based on an analysis of a multitude of variables, including real-time user performance data, coaching cues, and environmental factors, all in order to dynamically adjust the speed of the fitness machine 200.

In some cases, the speed of a moveable step of the fitness machine can be automatically adjusted 110. The moveable step 210 of the fitness machine can run along a track 245 based on the predetermined speed sequence. In other cases, the process 100 can then receive 115 a fitness level from a user of the fitness machine 200. The fitness level can also be retrieved 115 from a database if the fitness level is associated with the user of the fitness machine 200 in the database. Then, the process 100 can modify 120 the speed of the moveable step 210 based on the fitness level from the user. This can permit a user to use the automatic adjustment setting of the fitness machine 200 with a tailored speed that meets their particular fitness level. This embodiment allows the user to use the fitness machine 200 at a challenging pace that is tailored specifically for the user. For example, a novice user might not be able to keep up with a coach's speed in the video stream or class, so the user can send a fitness level via an application platform or on a panel on the fitness machine 200 to choose a ‘beginner’ level option for the tracks 245 on the fitness machine 200 to automatically reduce the speed proportionally according to the selected fitness level. The proportional reduced speed can continue to apply as the predetermined speed sequence increases and decreases the speed throughout the session.

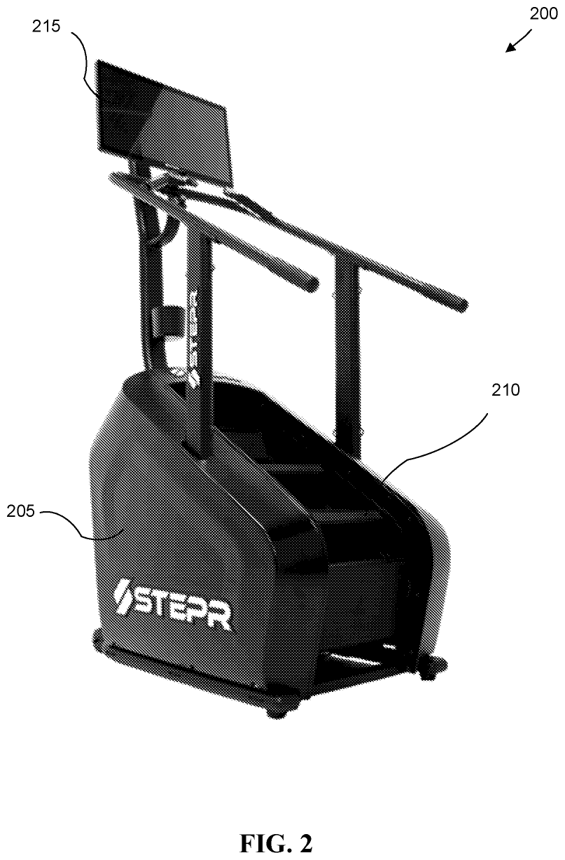

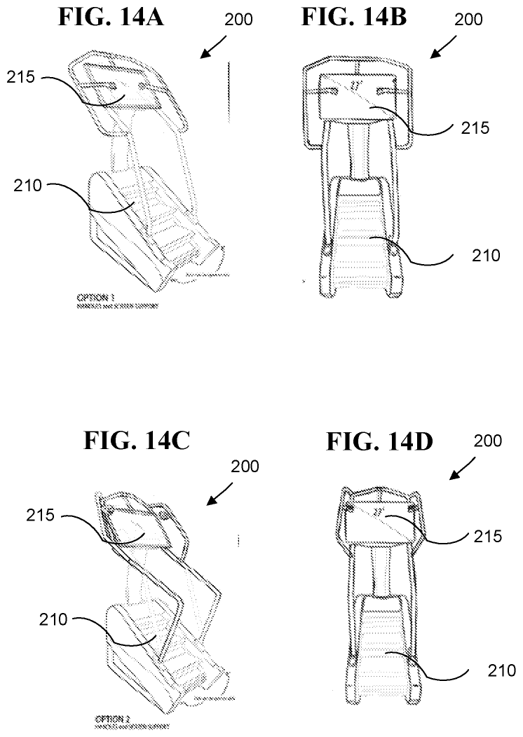

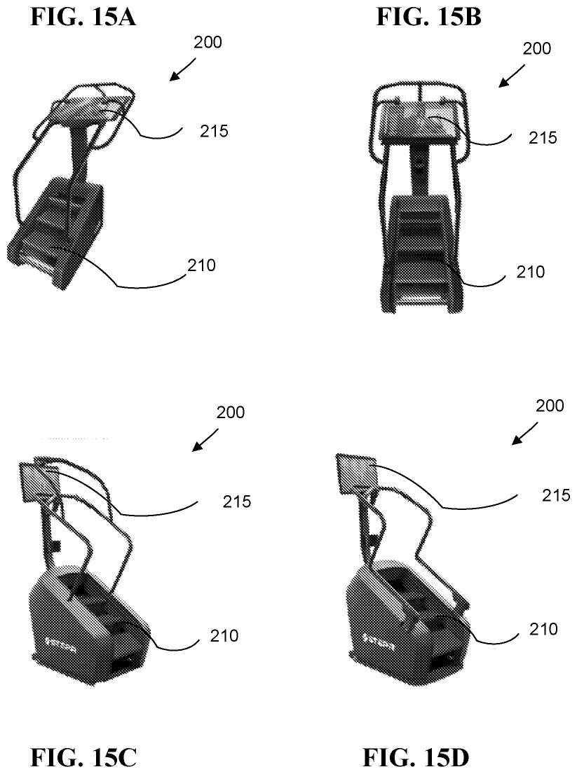

FIG. 2 is a perspective view of an example fitness machine 200 according to an example embodiment (FIGS. 14A-15D illustrate additional example views of the fitness machine 200). The fitness machine 200 can comprise of a frame 205. Various gears, chains, and components can connect a track 245 to the frame 205. The track 245 can be configured to guide at least a portion of a moveable step 210 along the track 245. There can be any number of moveable step 210 along the track 245. The moveable steps 210 along the track 245 can move in a circular motion into a hollow shell of the frame to create a never-ending revolving staircase model. The fitness machine 200 of the revolving staircase model can include additional embodiments to enhance the workout, durability, and usability of the fitness machine 200 as outlined below.

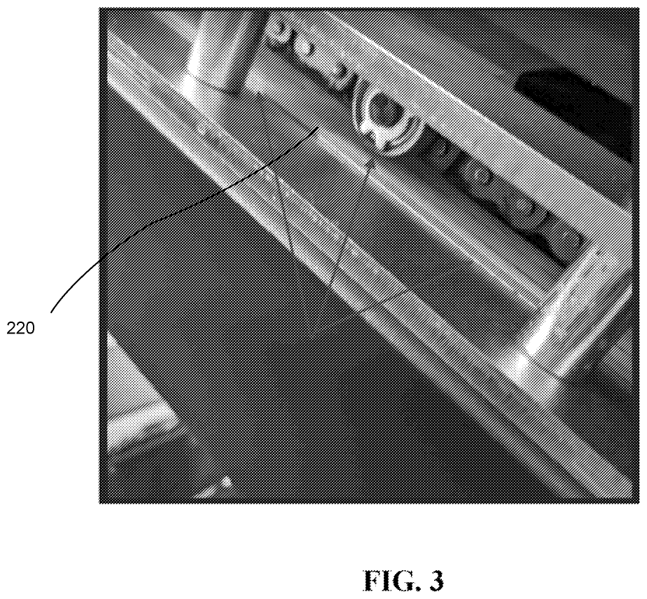

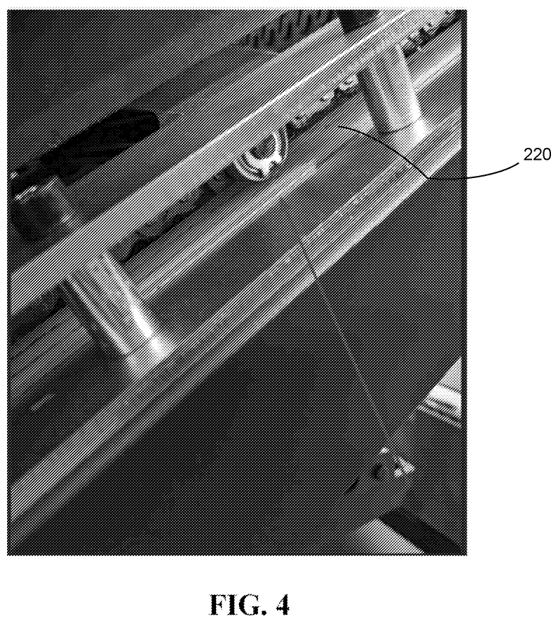

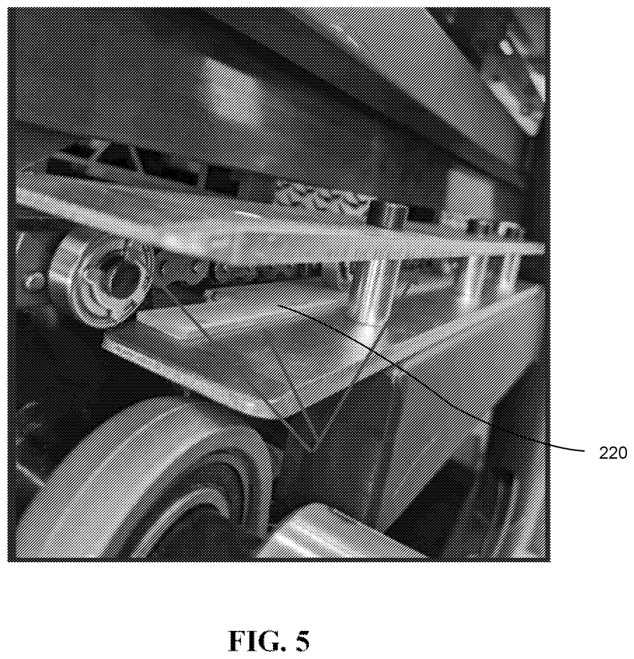

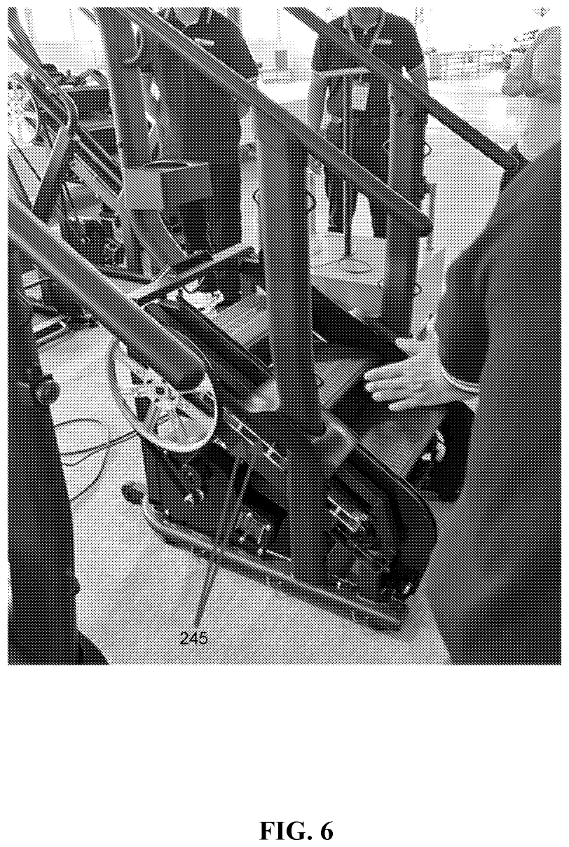

FIGS. 3-6 illustrate example images of a strip 220 on a track 245 of the fitness machine 200 according to an example embodiment. The present application discloses a fitness machine 200 with silent step sound strip noise quieting technology. This disclosure will allow the fitness machine 200 to be the quietest stair climber on the market. This disclosure significantly minimizes the inherent noise associated with steel-on-steel rotations involving the tracks 245, thereby ensuring a remarkably silent operational experience for users. This disclosure solves this problem by installing a polyurethane (PU) strip 220 directly to the stair tracks 245 on either individually a bottom portion of the tracks 245, a top portion of the tracks 245, or both as illustrated in FIGS. 3-6. The strip 220 can be installed directly on the tracks 245 at any portion where the tracks 245 make contact with any of the remaining parts of the fitness machine 220. This eliminates any direct bearing contact with the tracks 245 where the majority of the noise from the fitness machine 200 comes from, especially as speed increases. The noise is silenced that typically is generated from the stairs rolling over and the stair bearings hitting and running metal on metal. This disclosure eliminates the majority of the noise typically heard from a fitness stair machine. Traditional methods typically have bearings that run on a metal track 245. Of course, other materials beyond PU, such as ceramic, polymer, and plastic materials, can be used as long as the material imparts similar beneficial characteristics. The use of PU maintains the whisper-quiet operation of the fitness machine 200 and also enhances the durability and longevity of the equipment, making it a perfect addition to any home gym.

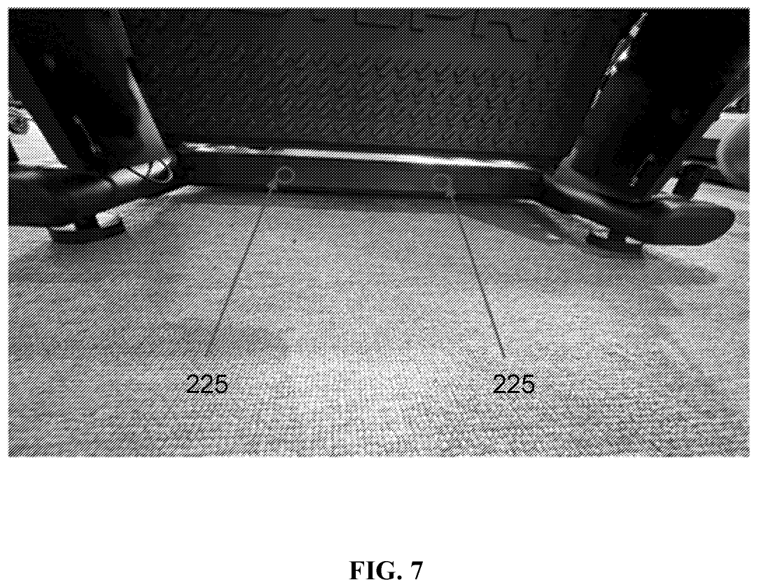

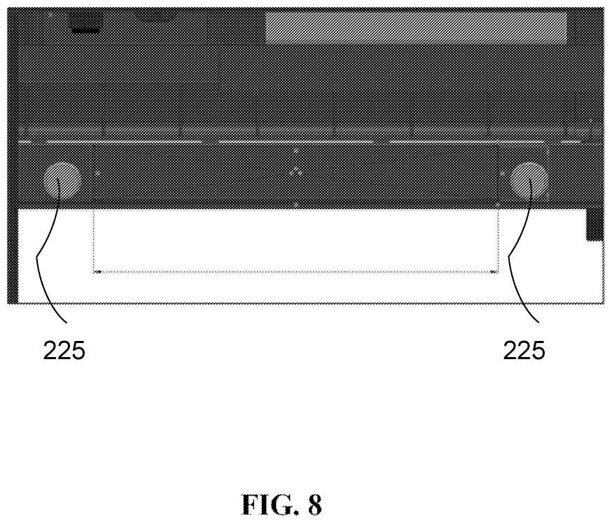

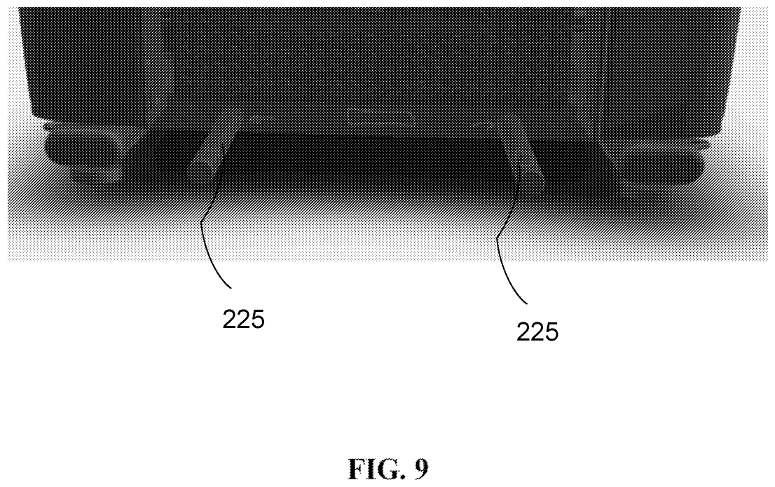

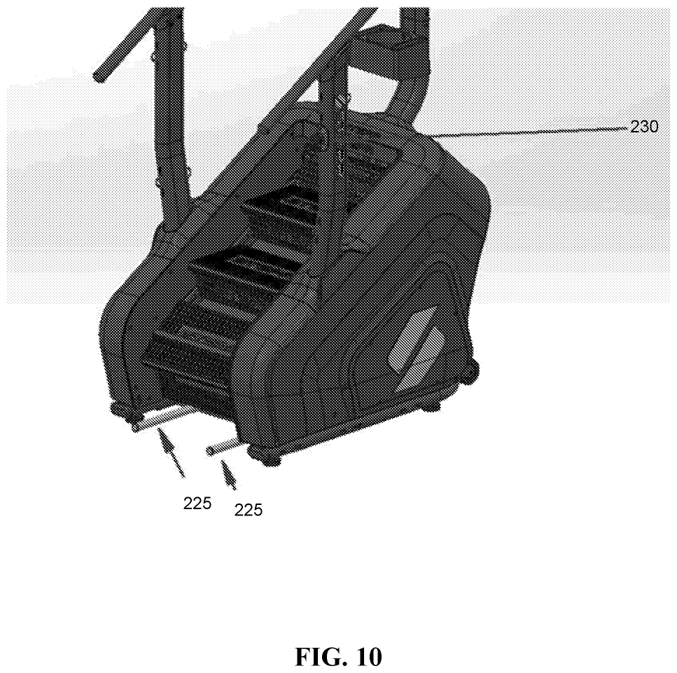

FIGS. 7 and 8 illustrate an example image of a threaded hold for a removable transport handle 225 according to an example embodiment. FIGS. 9 and 10 illustrate an example handle 225 according to an example embodiment. Another embodiment of the fitness machine 200 of the disclosure is the screw-in temporary transport handles 225. The handles 225 can be inserted and screwed into the threaded holes illustrated in FIGS. 7 and 8. The handles 225 can removably connected to the frame 205 via the threaded holes, the removeable handle being configured to assist with transportation of the fitness machine 200. The handles 225 can be connected to the frame 205 in other ways apart from using threaded holes. The track 245 can be attached to the frame 205 on a first side of the frame 205, and the removeable handle 225 can be connected to the first side of the frame 205 below the track 245 as illustrated in FIGS. 7 and 8. The handles 225 allow for the transformation of the fitness machine 200 to be transported in a similar way to a wheelbarrow with the goal to make transporting, installing and moving the fitness machine 200 around easier. The fitness machine can have at least two handles that screw directly into the base unit frame 205 under the bottom step 210 allowing you to pick up the fitness machine 200 like a wheelbarrow and easily wheel it around to your desired location. Then setting it down in place and unscrewing and removing the handles 225 to allow the user to resume normal function without the transport handles limiting use or being visible. The handles 225 can be designed to address the need for improved maneuverability and convenience in relocating and storing stair climbing fitness equipment. The handles 225 can be characterized by their extended grips and contoured design. These handles 225 can extend beyond the typical handholds found on fitness equipment, providing users with ample space to grip and maneuver the equipment with ease. The extended grips serve to enhance user comfort and control during the transport and placement of the stair climbing fitness equipment. Furthermore, the contoured design of these removable transport handles 225 can be specifically tailored to the human hand's natural ergonomics. This ergonomic design can help users maintain a secure and comfortable grip on the handles 225, reducing the risk of strain or discomfort during equipment relocation.

A notable feature of these handles 225 is the integration of built-in transport wheels. These wheels are strategically positioned to facilitate the effortless movement of the fitness machine 200, transforming it into a portable fitness device. The fitness machine 200 can further comprises a wheel connected to the frame 205 at a second side of the frame 205, and the second side of the frame 205 can be perpendicular to the first side of the frame 205 as illustrated in FIGS. 7-10. This feature eliminates the need for separate, bulky transportation mechanisms and streamlines the process of moving the fitness machine 200. The combination of the handles 225 with the built-in transport wheels assist in addressing the needs of both individual users and fitness facilities seeking to optimize the use of their space and equipment.

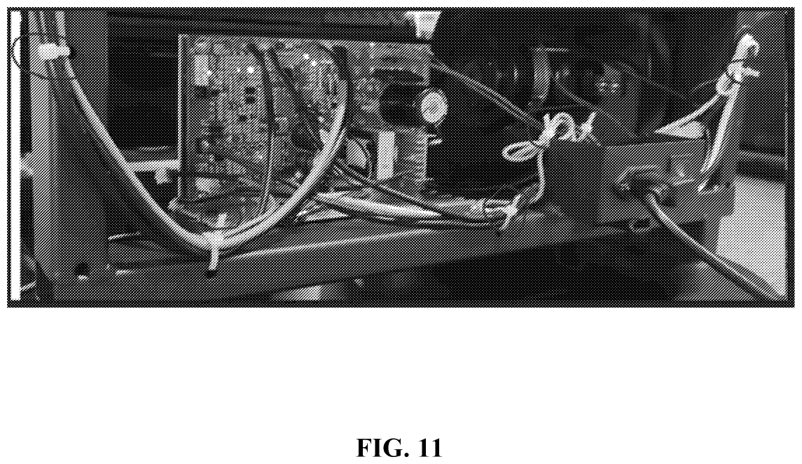

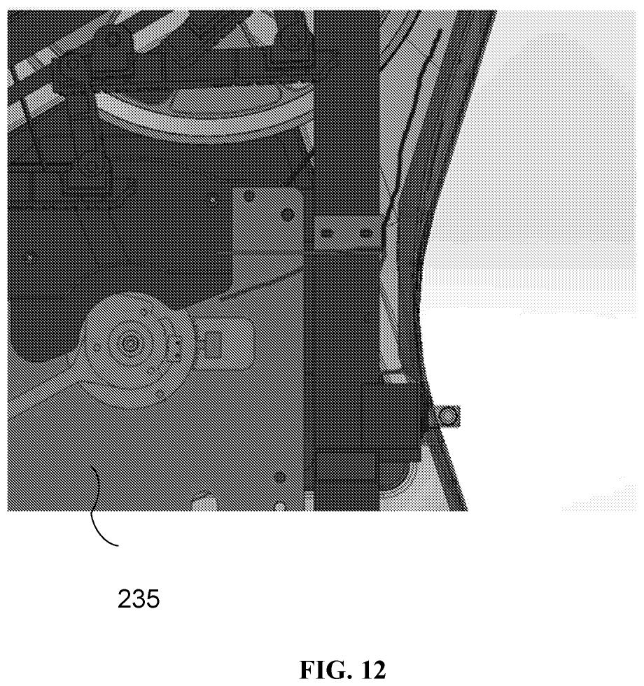

FIGS. 11 and 12 illustrate an example illustration of a shield 235 of internal electrical components of a fitness machine according to an example embodiment. The shields 235 for the fitness machine 200 can serve as a cover comprising metal or polymer materials that are meticulously contoured to envelop and shield vital internal components, including motors and electronics of the fitness machine 200. Their primary purpose is to safeguard these elements from the corrosive effects of sweat, which can lead to potential damage and compromise the longevity of the machine's performance. The internal shields 235 have been created to direct any moisture that enters the fitness machine 200 from sweat or other means away from the internal electronics. These shields 235 or covers serve as a protective barrier, strategically positioned within the fitness machine 200, to prevent sweat infiltration and the subsequent harm it can cause to sensitive components. The shield 235 can be a thin steel plate contoured around the internal electrical components of the fitness system 200. The fitness system 200 can comprise an internal shell with the internal electrical components and motor, and the shield 235 can be located within the internal shell surrounding the internal electrical components and motor. By doing so, they can help with the robust and enduring functionality of the fitness machine 200, enhancing its overall durability and operational reliability. This disclosure can help extend the lifespan of the equipment, reduce maintenance costs, and deliver a superior user experience.

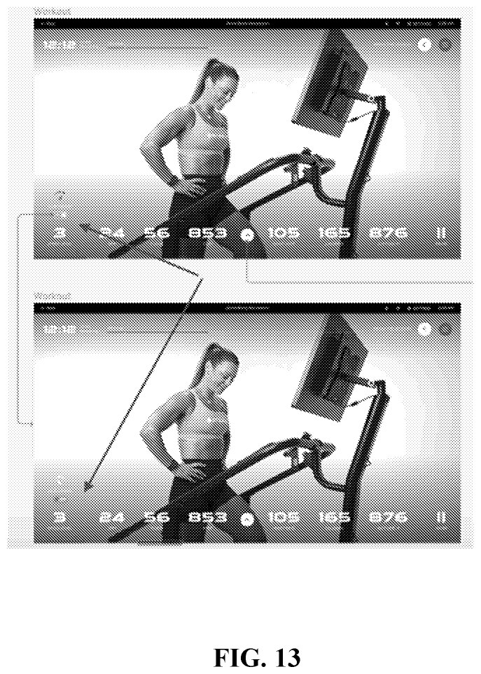

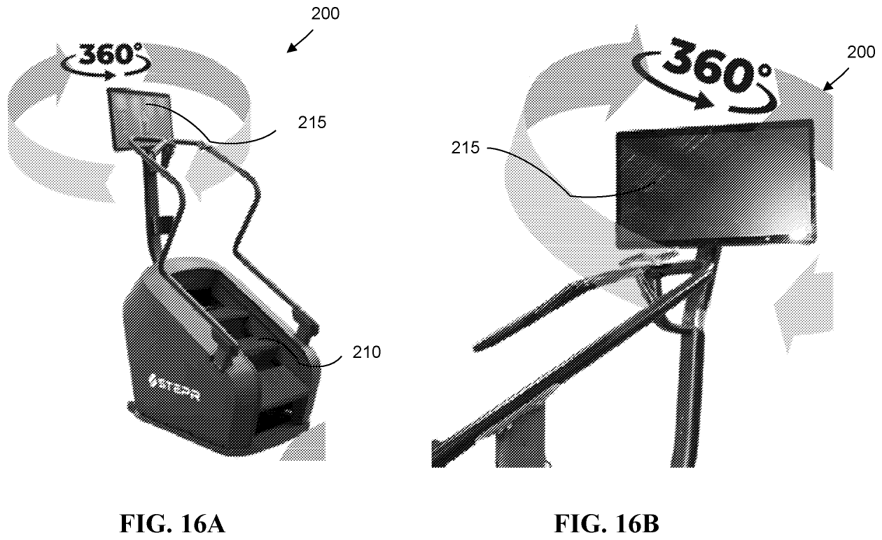

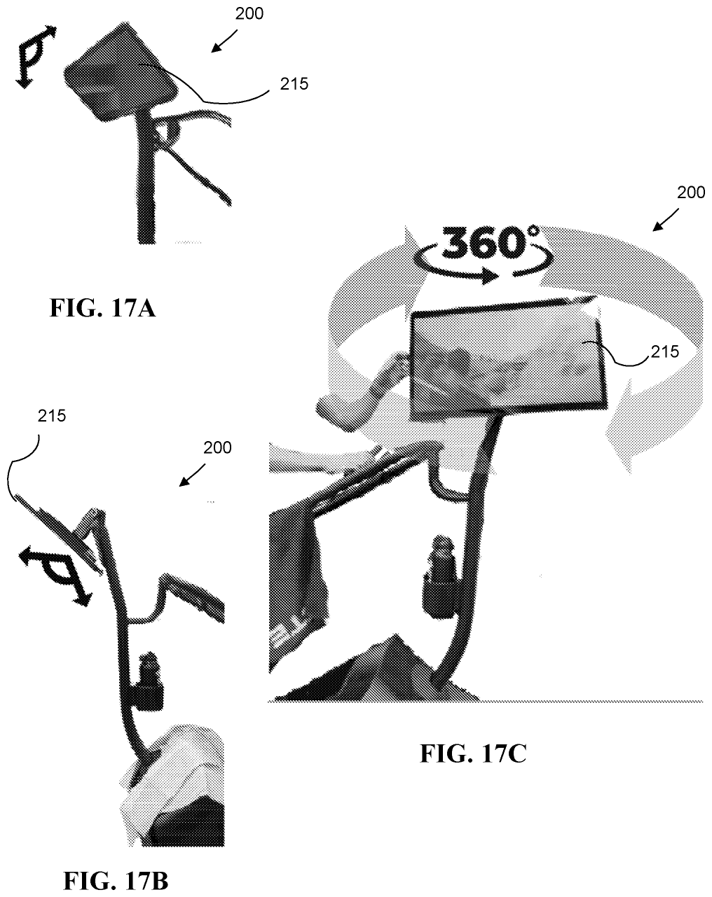

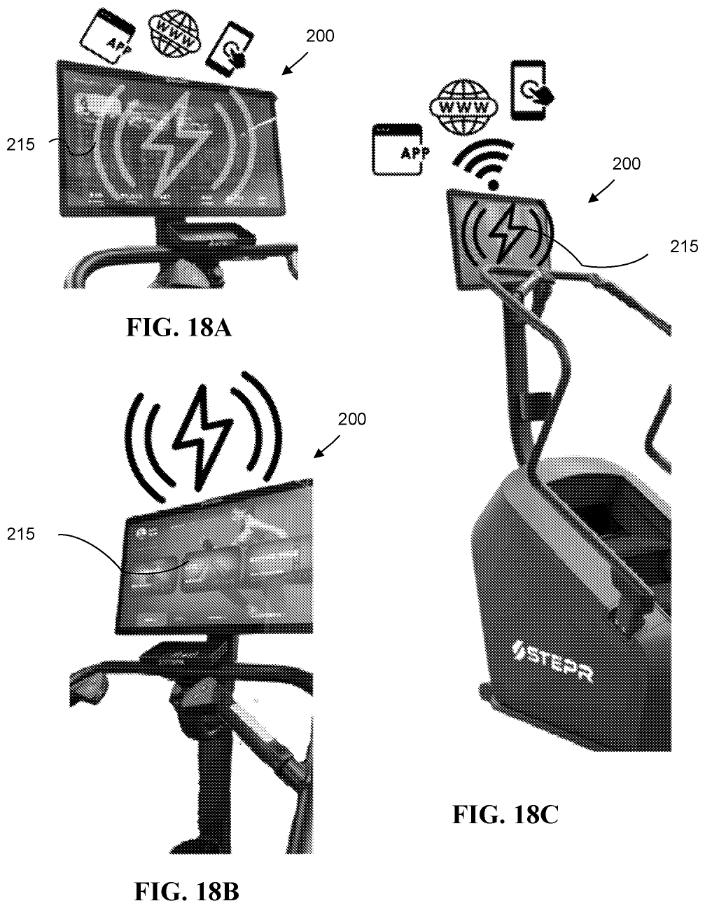

FIGS. 16A, 16B, and 17A-C illustrate example perspective views of a rotatable touchscreen 215 of a fitness machine 200 according to an example embodiment. FIGS. 18A-18C also illustrate example perspective views of graphical user interfaces displaying application on a rotatable touchscreen 215 of a fitness machine 200 according to an example embodiment. FIG. 13 illustrates an example graphical user interface that can display on the rotatable touchscreen 215 of the fitness machine 200 according to an example embodiment. The fitness machine 200 can also include a rotatable touchscreen 215 that can be rotated in any direction by at least 360 degrees. The fitness machine 200 can have a unique 360° rotatable and adjustable Android OS flat panel touchscreen 215 to allow the user to not only experience the immersive content-rich a customized application platform whilst using the fitness machine 200 for the stair stepping (stair climbing) feature but to also allow it to be moved and adjusted to face the user anywhere in the room when off the unit and working out following any of the other workout categories, including but not limited to, boot camp, stretching, yoga, strength & resistance training, mindfulness & meditation, scenic hikes and trail walks, coached classes, user-generated content, livestreaming sessions, and other exercises. The 360° rotatable touchscreen 215, seamlessly integrates into the fitness machine 200 and dynamically adapts, ensuring optimal viewing angles at all times during a user's workout. This disclosure eliminates distractions and fosters immersive engagement with the content that can be displayed using a graphical user interface on the touchscreen 215. The touchscreen 215 can extend to multi-axis tilting capabilities, allowing precise adjustments both horizontally and vertically to accommodate a user's ergonomic preferences. The touchscreen 215 can have a high-resolution display to help with the delivery of crisp and vivid visuals, immersing users in the content-rich environment of a customized application platform. The touchscreen's 215 can help by having highly responsive touch interface to allow users to navigate seamlessly through the customized application platform. The customized application platform can be designed for use with the fitness machine 200, to allow the fitness machine 200 settings to be controlled via a user interface. It empowers users to control the fitness machine 200 effortlessly through their mobile device. The fitness machine 200 can include a processor and memory in communication with the processor and storing instructions that when executed by the processor is configured to cause the fitness machine 200 to receive a signal. The signal can control the fitness machine 200 by controlling a motor of the fitness machine 200 to move a step 210 along a track 245 of the fitness machine 200 at a predetermined speed. The customized application platform can be used as a user interface to send the signal to the fitness machine 200 from a user device. The customized application platform can also allow a user to access a diverse array of on-demand workout video streams tailored to stair climbing and transmit them via their remote device to the fitness machine 200 to ensure seamless synchronization between the video stream and the speed of the machine (as outlined in the process 100 above). For example, the memory in communication with the processor can store instructions that when executed by the processor can be further configured to cause the fitness machine 200 to receive a selection of a video stream from the user via the customized application platform and transmit the video stream to a graphical user interface on the screen 215 of the fitness machine 200. Then, a command can be sent to the motor of the fitness machine 200 to move the step 210 along the track 245 based on a predetermined speed sequence in sync with the video stream. The customized application platform can facilitate a comprehensive and integrated fitness experience.

Whether selecting workout programs, customizing routines, or monitoring progress, each touch can be met with precision. The touchscreen 215 can use an operating system, to allow the touchscreen 215 to provide access to a diverse range of applications and connectivity options. The touchscreen 215 seamlessly can connect with external devices like heart rate monitors, headphones, and smartphones via Bluetooth technology. This disclosure can enhance user data tracking and provide audio support during workouts. The graphical user interface on the touchscreen 215 can enable users to create and manage personalized profiles, storing essential workout data in a memory of the fitness machine 200. This disclosure can grant users valuable insights into their fitness progress over time.

The graphical user interface of the touchscreen 215 can have a split screen functionality. The touchscreen 215 can comprise of one or more portions with each portion having a graphical user interface with content to be displayed (as outlined above). This disclosure allows users to simultaneously operate multiple applications, such as a workout class video stream alongside a streaming service, media playback, or social media application. This disclosure helps with efficient multitasking and a tailored workout experience.

The touchscreen 215 can be configured to display streaming platforms of the user's choice, such as Netflix, YouTube, Amazon, or others, while engaging in coach-led workout classes. This disclosure offers users the flexibility to stay engaged with their preferred media content. The touchscreen 215 can also be configured to have features such as image overlay, metric overlay, and customizable widget options. The image overly feature can seamlessly integrates visual elements onto the user's touchscreen 215, enhancing engagement and customization. Users can overlay images or graphics on the interface of the touchscreen 215, providing a personalized and dynamic experience. The metric overlay feature allows users to display on the graphical user interface of the touchscreen 215, real-time fitness data overlaid onto the touchscreen 215. This includes metrics such as heart rate, calorie burn, and step count, enabling users to track 245 their progress without interruption during their exercise routine. The customized widget options can allow users to tailor their touchscreen 215 with widgets of their choice. These widgets can display various information, including weather updates, news, or social media feeds, allowing for a fully personalized workout environment.

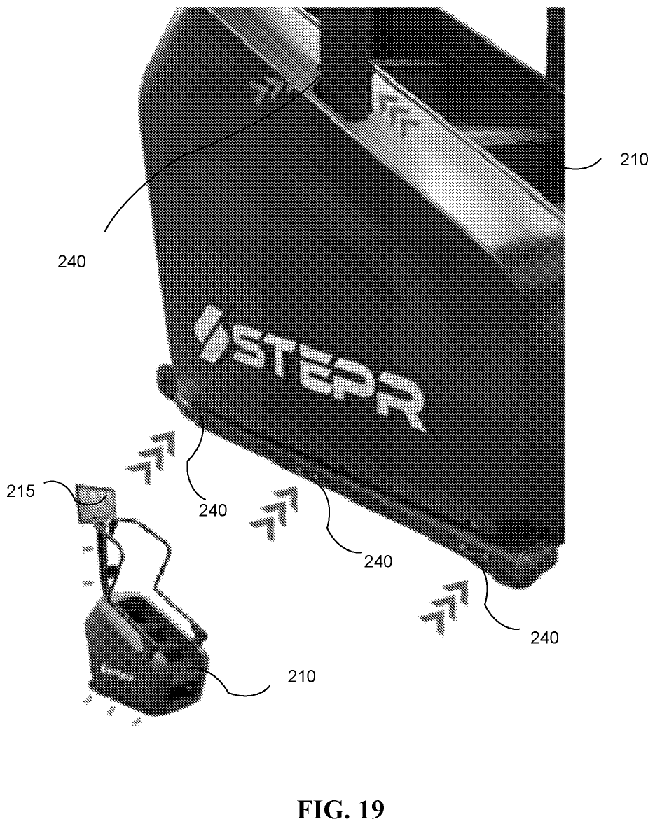

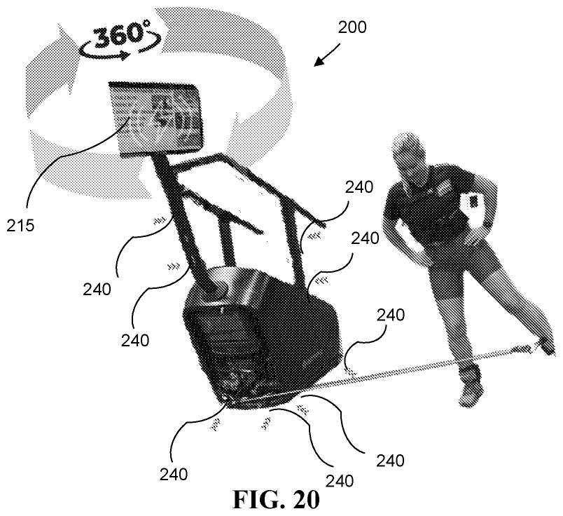

FIGS. 19 and 20 illustrate example perspective views of a fitness machine 200 with anchor points 240 according to an example embodiment. The fitness machine 200 can include anchor points 240 to allow strength attachments to be connected to the unit and used for resistance training or various other movements, like strength, stretching & mobility as illustrated in FIG. 20. The anchor points 240 can provide a secure and adaptable attachment point for the attachment of strength-enhancing accessories, thereby enabling users to partake in an array of resistance training, flexibility-enhancing stretches, and mobility exercises seamlessly. The anchor points 240 can allow users to connect stretch bands, workout bands, and carabiners, fostering a comprehensive fitness experience. This can extend the utility of the fitness machine 200, transforming it into a comprehensive fitness machine 200 suitable for various strength and conditioning routines. The anchor points 240 can be placed on the frame 205 of the fitness machine 200 at various height to allow for the versatility of workouts for the user.

In other embodiments, as illustrated in FIG. 10, the fitness machine 200 can include an auto sensing emergency stop embodiment for the fitness machine 200, wherein a controller of the fitness machine 200 can utilize sensors 230 to continuously monitor user presence. The sensors 230 can be attached to a frame of the fitness machine 200 and configured to dynamically monitor a presence of a user on the step 210. When the absence of a user is detected, the system can initiate an immediate emergency stop, prioritizing user safety by minimizing response time and potential risks. A machine learning model can use the built-in sensors 230 as a safety feature that allows the fitness machine 200 to detect if the user needs help or is in trouble. Once a safety hazard is detected, a controller of the fitness machine 200 can shut off the fitness machine 200 by stopping the movement of the tracks 245 with the steps 210. The machine learning model can be trained to identify the safety hazard based on marked indicators in historical safety hazard data. For example, if a safety hazard event is reported via the customized application to the fitness machine 200, the safety hazard event can be analyzed for indicators that could have predicted the safety hazard event. The indicators can be marked and stored in the memory of the fitness machine 200 for training of the machine learning model. The indicators, for example, can be received from a user of the fitness machine 200 or be aggregated based on feedback and data received from a plurality of fitness machines 200 (e.g., each fitness machine 200 can be connected to a remote server and the remote server can collect data from each of the fitness machines 200 no matter where in the world they are located so long as they are connected to the internet). The machine learning model can be retrained after the safety hazard incident using the marked indicators from the safety hazard incident.

An embodiment of the present disclosure may be implemented according to at least the following:

Clause 1: A fitness machine comprising: a moveable step; a track configured to guide at least a portion of the moveable step along the track; and a strip disposed on the track, the strip being configured to reduce sound output by the fitness machine.

Clause 2: The fitness machine of clause 1, wherein the strip comprises a polyurethane material.

Clause 3: The fitness machine of clause 1, wherein the strip comprises a polymer material.

Clause 4: The fitness machine of clause 2 or 3, wherein the track comprises a top portion and a bottom portion and wherein the strip is placed on at least a portion of the top portion, the bottom portion, or a combination thereof.

Clause 5: The fitness machine of clause 1, wherein the fitness machine further comprises: a frame configured to support the track; and a removeable handle removably connected to the frame, the removeable handle being configured to assist with transportation of the fitness machine.

Clause 6: The fitness machine of clause 5, wherein the removeable handle comprises a first removeable handle and a second removable handle, wherein the track is attached to the frame on a first side of the frame, and wherein the first removeable handle and the second removable handle are connected to the first side of the frame below the track.

Clause 7: The fitness machine of clause 5, wherein the removeable handle is contoured to provide an ergonomic hand grip.

Clause 8: The fitness machine of clause 5, wherein the fitness machine further comprises a wheel connected to the frame at a second side of the frame, and wherein the second side of the frame is perpendicular to the first side of the frame.

Clause 9: The fitness machine of any of the preceding clauses, wherein the fitness machine further comprises an anchor point on an external surface of the frame.

Clause 10: The fitness machine of clause 9, wherein the anchor point is configured to allow an attachment to be connected to the frame at the anchor point.

Clause 11: The fitness machine of any of the preceding clauses, wherein the fitness machine further comprises a rotatable screen coupled to the frame, and wherein the rotatable screen is configured to rotate about an axis horizontally and vertically.

Clause 12: The fitness machine of clause 11, wherein the rotatable screen is configured to rotate about the axis by at least 360 degrees.

Clause 13: The fitness machine of clause 11 or 12, wherein the rotatable screen comprises at least two regions, wherein a graphical interface is configured to display in at least one of the at least two regions of the rotatable screen, and wherein the graphical interface is configured to display an application.

Clause 14: The fitness machine of clause 13, wherein the graphical interface is configured to overlay at least one of: an image, a metric, or a widget.

Clause 15: The fitness machine of clause 14, wherein the metric comprises data tracking usage progress and health data of a user of the fitness machine.

Clause 16: A fitness system comprising: a moveable step; a track configured to guide at least a portion of the moveable step along the track; and a controller configured to: receive instructions from a remote server, the instructions comprising a predetermined speed sequence; and automatically adjust a speed of the moveable step along the track based on the predetermined speed sequence.

Clause 17: The fitness system of clause 16, wherein the predetermined speed sequence is determined at least in part by a remote fitness instructor.

Clause 18: The fitness system of clause 16 or clause 17, wherein the predetermined speed sequence comprises at least two predetermined speeds and wherein the predetermined speeds are configured to mimic a terrain.

Clause 19: The fitness system of clause 16, 17, or 18, wherein the predetermined speed sequence corresponds to a video stream.

Clause 20: The fitness system of clause 19, wherein the fitness system further comprises a display configured to display the video stream, the video stream comprising communication from the remote fitness instructor.

Clause 21: The fitness system of any of clauses 16-20, wherein the controller is further configured to modify the predetermined speed sequence based on a fitness level of a user of the fitness system, the fitness level being received from the user.

Clause 22: The fitness system of clause 21, wherein the predetermined speed sequence is modified by reducing the predetermined speeds in the predetermined speed sequence proportionally based on the fitness level.

Clause 23: The fitness system of any of clauses 16-20, wherein the controller is further configured to: receive data comprising a selected speed from a remote device; and automatically adjust the speed of the moveable step based on the selected speed.

Clause 24: The fitness system of clause 23, wherein the controller is further configured to: receive a fitness level from a user of the fitness system; and modify the selected speed based on the fitness level by adjusting the selected speed proportionally based on the fitness level.

Clause 25: The fitness system of clause 23 or 24, wherein the controller is further configured to: receive a command from a user corresponding to a selected speed to disengage the automatic adjustment of the speed of the moveable step; and adjust the speed of the moveable step to the selected speed.

Clause 26: The fitness system of clause 25, wherein the controller is further configured to: receive a command from a user to activate the automatic adjustment of the speed of the moveable step; and automatically adjust the speed of the moveable step based on the predetermined speed sequence.

Clause 27: The fitness system of clause 26, wherein the controller is configured to adjust the speed of the moveable step based on a historical usage data of a user of the fitness system to tailor the speed to a fitness level of a user of the fitness system.

Clause 28: The fitness system of any of clauses 16-27, wherein the fitness system further comprises a removeable handle removably connected to a frame of the fitness system, the removeable handle being configured to assist with transportation of the fitness system.

Clause 29: The fitness system of clause 28, wherein the removeable handle comprises a first removeable handle and a second removeable handle, wherein the track is attached to the frame on a first side of the frame, and wherein the first removeable handle and second removeable handle are each connected to the first side of the frame below the track.

Clause 30: The fitness system of clause 28 or clause 29, wherein the removeable handle is contoured to provide an ergonomic hand grip.

Clause 31: The fitness system of any of clauses 28-30, wherein the fitness system further comprises a wheel connected to the frame at a second side of the frame, and wherein the second side of the frame is perpendicular to the first side of the frame.

Clause 32: The fitness system of any of clauses 16-31, wherein the fitness system further comprises an anchor point on an external surface of the frame.

Clause 33: The fitness system of clause 32, wherein the anchor point is configured to allow an attachment to be connected to the frame at the anchor point.

Clause 34: The fitness system of any of clauses 16-33, wherein the fitness system further comprises a rotatable screen coupled to the frame, and wherein the rotatable screen is configured to rotate about an axis horizontally and vertically.

Clause 35: The fitness system of clause 34, wherein the rotatable screen is configured to rotate about the axis by at least 360 degrees.

Clause 36: The fitness system of clause 35, wherein the rotatable screen comprises at least two regions, wherein a graphical interface is configured to display in at least one of the at least two regions of the rotatable screen, and wherein the graphical interface is configured to display an application.

Clause 37: The fitness system of clause 36, wherein the graphical interface is configured to overlay at least one of: an image, a metric, or a widget.

Clause 38: The fitness system of clause 37, wherein the metric comprises data tracking usage progress and health data of a user of the fitness system.

Clause 39: The fitness system of any of clauses 16-38, wherein the fitness system further comprises a motor and internal electrical components connected to the track to move the moveable step, and wherein the fitness system further comprises a shield covering the motor or internal electrical components and configured to prevent liquid from contacting the motor or internal electrical components.

Clause 40: The fitness system of clause 39, wherein the shield comprises a steel material.

Clause 41: The fitness system of clause 40, wherein the shield is configured to envelop at least a portion of the motor or internal electrical components and direct the liquid away from the motor or internal electrical components.

Clause 42: The fitness system of clause 41, wherein the shield is a thin metal plate contoured around the internal electrical components of the fitness system.

Clause 43: The fitness system of clause 41, wherein the frame of the fitness system comprises an internal shell with the internal electrical components and motor, and wherein the shield is located within the internal shell surrounding the internal electrical components and motor.

Clause 44: A fitness system comprising: a processor; and a memory in communication with the processor and storing instructions that when executed by the processor are configured to cause the fitness system to: transmit a signal to a fitness machine, the signal being configured to change a speed of a motor of the fitness machine to move a step along a track of the fitness machine at a predetermined speed.

Clause 45: The fitness system of clause 44, wherein the instructions are further configured to cause the fitness system to: receive a selection of a video stream from a user; and transmit the video stream to a screen of the fitness machine and instructions to the fitness machine to cause the motor to move the step along the track based on a predetermined speed sequence in sync with the video stream.

Clause 46: The fitness system of clause 44 or 45 further comprising a sensor attached to a frame of the fitness machine configured to dynamically monitor a presence of a user on the step.

Clause 47: The fitness system of clause 46, wherein the instructions are further configured to cause the fitness system to: receive data from the sensor; and based at least in part on the data received from the sensor being indicative of a user no longer being present, output a signal to stop a movement of the step along the track.

Clause 48: The fitness system of clause 47, wherein the instructions are further configured to cause the fitness system: determine, based at least in part on data from the sensor and using a machine learning model, whether a safety hazard is present; and in response to determining that there is the safety hazard present, stop the movement of the step along the track.

Clause 49: The fitness system of clause 48, wherein the machine learning model is trained to identify the safety hazard based on marked indicators in historical safety hazard data.

Clause 50: The fitness system of clause 48, wherein the machine learning model is retrained after a safety hazard incident using marked indicators from the safety hazard incident.

As used in this application, the terms “component,” “module,” “system,” “server,” “processor,” “memory,” and the like are intended to include one or more computer-related units, such as but not limited to hardware, firmware, a combination of hardware and software, software, or software in execution. For example, a component may be, but is not limited to being, a process running on a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Certain embodiments and implementations of the disclosed technology are described above with reference to block and flow diagrams of systems and methods and/or computer program products according to example embodiments or implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, may be repeated, or may not necessarily need to be performed at all, according to some embodiments or implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

As an example, embodiments or implementations of the disclosed technology may provide for a computer program product, including a computer-usable medium having a computer-readable program code or program instructions embodied therein, said computer-readable program code adapted to be executed to implement one or more functions specified in the flow diagram block or blocks. Likewise, the computer program instructions may be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

In this description, numerous specific details have been set forth. It is to be understood, however, that implementations of the disclosed technology may be practiced without these specific details. In other instances, well-known methods, structures and techniques have not been shown in detail in order not to obscure an understanding of this description. References to “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form. By “comprising” or “containing” or “including” is meant that at least the named element, or method step is present in article or method, but does not exclude the presence of other elements or method steps, even if the other such elements or method steps have the same function as what is named.

As used herein, unless otherwise specified the use of the ordinal adjectives “first,” “second,” “third,” etc., to describe a common object, merely indicate that different instances of like objects are being referred to and are not intended to imply that the objects so described must be in a given sequence, either temporally, spatially, in ranking, or in any other manner.

While certain embodiments of this disclosure have been described in connection with what is presently considered to be the most practical and various embodiments, it is to be understood that this disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the technology and also to enable any person skilled in the art to practice certain embodiments of this technology, including making and using any apparatuses or systems and performing any incorporated methods. The patentable scope of certain embodiments of the technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A fitness machine comprising:
a moveable step;
a track configured to guide at least a portion of the moveable step along the track; and
at least one of:
a strip disposed on the track, the strip being configured to reduce sound output by the fitness machine; or
an anchor point configured to support the track.

2. The fitness machine of claim 1, wherein the strip comprises a material selected from a group consisting of a polyurethane material and a polymer material.

3.-4. (canceled)

5. The fitness machine of claim 2 further comprising:
a frame configured to support the track; and
a removeable handle removably connected to the frame, the removeable handle being configured to assist with transportation of the fitness machine;
wherein the anchor point is on an external surface of the frame.

6. The fitness machine of claim 5, wherein at least one of:
the removeable handle comprises a first removeable handle and a second removable handle, the track is attached to the frame on a first side of the frame, and the first removeable handle and the second removable handle are connected to the first side of the frame below the track;
the removeable handle is contoured to provide an ergonomic hand grip;
the fitness machine further comprises a wheel connected to the frame at a second side of the frame, and the second side of the frame is perpendicular to the first side of the frame; or
the anchor point is configured to allow an attachment to be connected to the frame at the anchor point.

7.-10. (canceled)

11. The fitness machine of claim 6 further comprising:
a rotatable screen coupled to the frame, the rotatable screen being configured to rotate about an axis horizontally and vertically.

12. The fitness machine of claim 11, wherein the rotatable screen is configured to rotate about the axis by at least 360 degrees.

13. The fitness machine of claim 11, wherein:
the rotatable screen comprises at least two regions;
a graphical interface is configured to display in at least one of the at least two regions of the rotatable screen; and
the graphical interface is configured to display an application.

14. The fitness machine of claim 13, wherein the graphical interface is configured to overlay at least one of: an image, a metric, or a widget.

15. The fitness machine of claim 14, wherein the metric comprises data tracking usage progress and health data of a user of the fitness machine.

16. A fitness system comprising:
the fitness machine of claim 1; and
a controller configured to:
receive instructions from a remote server, the instructions comprising a predetermined speed sequence; and
automatically adjust a speed of the moveable step along the track based on the predetermined speed sequence.

17. The fitness system of claim 16, wherein:
the fitness machine further comprises a frame configured to support the track; and
the predetermined speed sequence at least one of:
is determined at least in part by a remote fitness instructor;
comprises at least two predetermined speeds, the predetermined speeds configured to mimic a terrain; or
corresponds to a video stream.

18.-19. (canceled)

20. The fitness system of claim 17 further comprising one or more of:
a display;
a removeable handle removably connected to the frame;
a wheel;
an anchor point on an external surface of the frame;
a rotatable screen coupled to the frame;
a motor and internal electrical components connected to the track and configured to move the moveable step; or
a shield.

21. The fitness system of claim 20, wherein:
the controller is further configured to modify the predetermined speed sequence based on a fitness level of a user of the fitness system, the fitness level being received from the user; and
at least one of:
the display is configured to display the video stream, the video stream comprising communication from the remote fitness instructor;
the removeable handle is configured to assist with transportation of the fitness system and comprises a first removeable handle and a second removeable handle, the track being attached to the frame on a first side of the frame, and the first removeable handle and second removeable handle are each connected to the first side of the frame below the track;
the wheel is connected to the frame at a second side of the frame, the second side of the frame being perpendicular to the first side of the frame
the anchor point is configured to allow an attachment to be connected to the frame at the anchor point;
the rotatable screen is configured to rotate about an axis horizontally and vertically; or
the shield is configured to cover the motor and/or internal electrical components to limit liquid from contacting the motor and/or internal electrical components.

22. (canceled)

23. The fitness system of claim 21, wherein the controller is further configured to:
receive data comprising a selected speed from a remote device; and
automatically adjust the speed of the moveable step based on the selected speed.

24. The fitness system of claim 23, wherein the controller is further configured to:
receive a fitness level from a user of the fitness system; and
modify the selected speed based on the fitness level by adjusting the selected speed proportionally based on the fitness level.

25. The fitness system of claim 23, wherein the controller is further configured to:
receive a command from a user corresponding to a selected speed to disengage the automatic adjustment of the speed of the moveable step; and
adjust the speed of the moveable step to the selected speed.

26. The fitness system of claim 25, wherein the controller is further configured to:
receive a command from a user to activate the automatic adjustment of the speed of the moveable step; and
automatically adjust the speed of the moveable step based on the predetermined speed sequence.

27. The fitness system of claim 21, wherein at least one of:
the controller is further configured to adjust the speed of the moveable step based on a historical usage data of a user of the fitness system to tailor the speed to the fitness level of a user of the fitness system;
the removeable handle is contoured to provide an ergonomic hand grip; or
the rotatable screen is configured to rotate about the axis by at least 360 degrees.

28.-43. (canceled)

44. The fitness system of claim 16 further comprising:
a processing platform comprising at least one processor; and
memory in communication with the processing platform and storing instructions that, when executed by the processing platform, are configured to:
transmit a signal to the controller, the signal being configured to change a speed of the moveable step along the track based on the predetermined speed sequence.

45. The fitness system of claim 44 further comprising:
a sensor attached to a frame of the fitness machine configured to dynamically monitor a presence of a user on the step;
wherein the instructions are further configured to:
receive a selection of a video stream from a user;
transmit the video stream to a screen of the fitness machine and instructions to the fitness machine to cause a motor of the fitness machine to move the step along the track based on the predetermined speed sequence in sync with the video stream;
receive data from the sensor;
based at least in part on the data received from the sensor being indicative of a user no longer being present, output a signal to stop a movement of the step along the track;
determine, based at least in part on data from the sensor and using a machine learning model, whether a safety hazard is present; and
in response to determining a safety hazard is present, stop the movement of the step along the track; and
wherein the machine learning model is:
trained to identify the safety hazard based on marked indicators in historical safety hazard data; and
retrained after a safety hazard incident using marked indicators from the safety hazard incident.

46.-50.
